(19) United States
(12) Patent Application Publication
(10) Pub. No.: US 2012/0267062 A1
(43) Pub. Date: Oct. 25, 2012

(54) Box Canvas Apparatus and Method

(75) Inventor: Andrew Ainge, Menston (GB)

(73) Assignee: BLANC CANVAS LTD, Leeds Yorkshire (GB)

(21) Appl. No.: 13/382,943

(22) PCT Filed: Jul. 3, 2009
(86) PCT No.: PCT/GB2009/050785

§ 371 Date: Apr. 20, 2012

(30) Foreign Application Priority Data
Jul. 3, 2008 (GB) 0812145.1

(51) Int. Cl. A47G 5/00; B23P 11/00

(52) U.S. Cl. 160/371; 29/428

(57) ABSTRACT

A box canvas apparatus and method is described. The apparatus comprises a canvas and frame means, said canvas having a front surface and a rear surface. The rear surface of the canvas comprises marking means defined thereon for marking out the location of said frame means in use. The apparatus further includes attachment means for attaching the frame means to the canvas when positioned in a correct location on the marking means.

This invention relates to apparatus and a method for forming a box canvas.

A box canvas, or stretch canvas as it is also known, is a canvas which has been stretched around a box shaped frame. The front and side walls of the box canvas is normally for the display of an image or artwork thereon. No staples or canvas tacks are visible from the front or sides of the canvas and the canvas is typically attached to the box shaped frame on a rear surface thereof. As such, a neat and modern display means is produced.

A problem with box canvas artwork is that it is generally expensive to make and buy and requires a high level of expertise to produce. As such, box canvases are mostly produced by professional picture framers. The picture framer is required to produce and construct a box frame to required measurements according to the customer specification and the size of the canvas. The canvas is then stretched over the box frame and hand stapled around the rear when in the stretched configuration. This tends to be skilled worked requiring special tools. Box canvas prints are also bulky when finished meaning the cost of packaging and delivery is high. Furthermore, traditional box canvas prints use wood which means the product is not suitable for wet areas or outdoors. Many digital print businesses have to outsource the framing which is costly and can take time.

It is therefore an aim of the present invention to provide box canvas apparatus which allows easy and cost effective assembly and which can be undertaken by a user at home without using a professional picture framer. Also to produce a product that is easy to package and easy to ship. Furthermore, a product that can be used in many locations without the limitations associated with traditional frames.

It is a further aim of the present invention to provide a method for producing box canvas which addresses the abovementioned and other problems.

According to a first aspect of the present invention there is provided box canvas apparatus, said apparatus including a canvas and frame means, said canvas having a front surface and a rear surface, the rear surface having marking means defined thereon for marking out the location of said frame means in use, said apparatus further including attachment means for attaching the frame means to the canvas when positioned in a correct location on the marking means.

Preferably, the frame means includes a plurality of frame members which are assembled in use to define a box frame over which the canvas is stretched. The frame members are typically provided in the correct dimensions, shape and/or size for the size of the canvas.

At least some of the frame members are located on the marking means on the rear surface of the canvas during assembly and are attached to the canvas and/or to adjacent frame members via the attachment means.

Preferably, each frame member has a unique label that corresponds to a label defined by the marking means, thereby allowing a user to determine the location of each frame member on the rear of the canvas. Preferably, the unique labels are printed on the marking means. Alternatively the canvas comprises a label defined by the marking means upon output from a computer program.

Further preferably the marking means also define the correct orientation of the frame members on the canvas.

Preferably the frame members include location means for locating one or more further frame members and/or engagement means therewith. In one example the further frame members include support members for locating diagonally across the corners of the frame between two adjacent frame members, thereby providing the frame with rigidity and strength.

In one embodiment the frame members are located initially on or adjacent a peripheral edge of the rear surface of the canvas. The location means preferably face outwardly of the canvas. As the box frame is constructed, the frame members and canvas are moved through approximately 90 degrees inwardly of the canvas. The longitudinal axis of the location means are now substantially transverse to the main canvas.

Preferably at least one free end of the frame member is provided with a pre-determined taper or angle to allow adjacent ends of the frame member to be brought together into engagement to define a corner of a pre-determined angle. When the frame member is initially located on the canvas, the tapered end typically slopes towards the canvas.

In one embodiment the location means includes one or more grooves, apertures or recesses. The longitudinal axis of the location means are typically moved from a first position, wherein it is substantially parallel to the plane of the main canvas, to a second position during construction, wherein it is substantially transverse to the plane of the main canvas.

The engagement means can include one or more pins, staples, clips and/or the like. Preferably, the engagement means include one or more clips.

Preferably the frame means are attached to the canvas by adhesive, hook and loop material, one or more pins, staples, clips and/or the like. More preferably, the frame means are attached to the canvas by an adhesive, preferably a water-proof adhesive. Preferably, the adhesive is an adhesive tape with a release liner.

In a preferred embodiment the attachment means are in the form of adhesive located on one or more parts of the rear of the canvas with a removable backing layer associated with the same. The backing layer can be removed and the frame means adhered directly to the canvas in the correct location. Preferably, the attachment means are located on one or more frame member, more preferably on each frame member.

The canvas is formed from a material which is sufficiently flexible and/or resilient to allow the same to be stretched over the frame means in use. The canvas is typically in the form of a sheet like material.

By the term “canvas”, it is meant any sufficiently flexible and/or resilient material. For example, when used herein, the term “canvas” includes traditional woven cotton canvas, woven and non-woven natural and man-made fabric materials, paper, cardboard, plastic and metals.

Preferably, the apparatus is constructed from recycled materials. The marking means can be defined on the rear of the canvas and can be located thereon via any suitable means, such as via printing, painting, hand drawn and/or the like.

The front surface of the canvas typically has one or more images, art work and/or the like provided thereon or capable of being provided thereon. The one or more images, art work and/or the like can be provided on the canvas before or after the canvas is attached to the frame means.

Hanging means can be provided on or associated with the frame means to allow the box canvas to be hung from a suitable wall surface in use. The hanging means can include one or more apertures, hooks, wire, string and/or the like.

The apparatus may further be provided with lighting means to illuminate the canvas. Preferably, the lighting means comprise a back-light to illuminate the canvas from the rear of the frame apparatus. Alternatively, the lighting means may comprise an LED array.

The apparatus may also comprise a sound system. The sound system preferably comprises speakers. The sound system may also comprise a sound input means, for example a CD player, MP3 player, hard drive with sound processing means, or the like.

According to a second aspect of the present invention there is provided a method of forming a box canvas, said method including the steps of locating frame means onto marking means defined on a rear surface of a canvas, and attaching the canvas to the frame means to stretch the canvas over the frame means to form the final box canvas.

According to a further aspect of the present invention there is provided self assembly box canvas apparatus.

According to a yet further aspect of the present invention there is provided a kit of parts for forming a box canvas.

The advantage of the self assembly construction compared to the pre-assembled construction is that the box canvas can be stored and transported in a substantially collapsed state prior to erection, thereby saving space and money.

Embodiments of the present invention will now be described with reference to the accompanying figures, wherein:

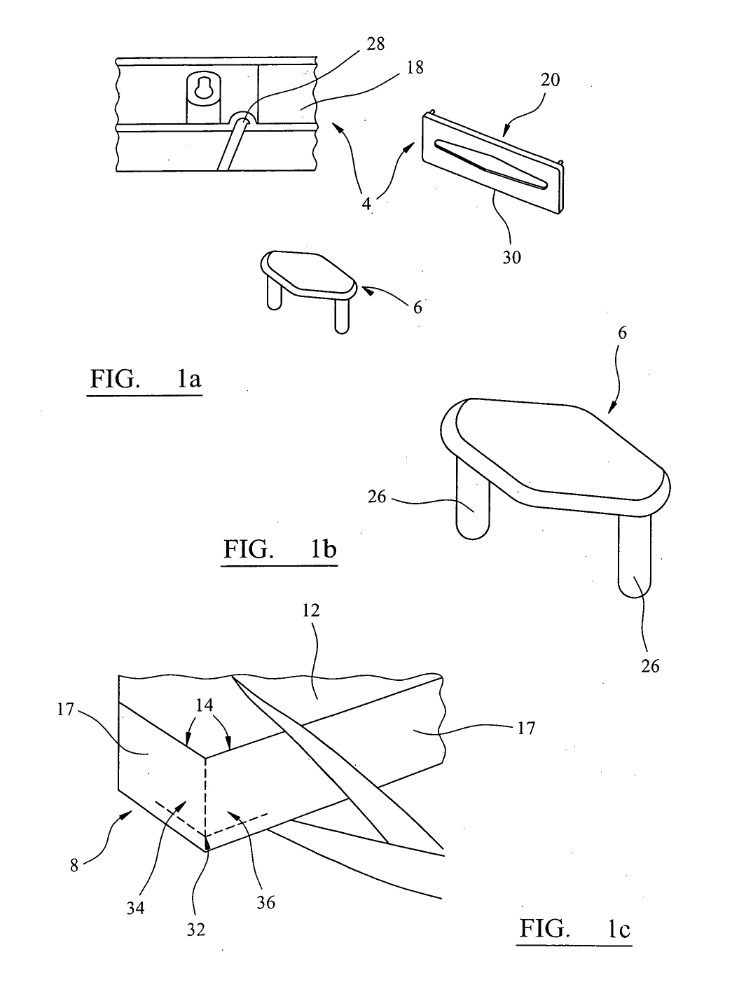

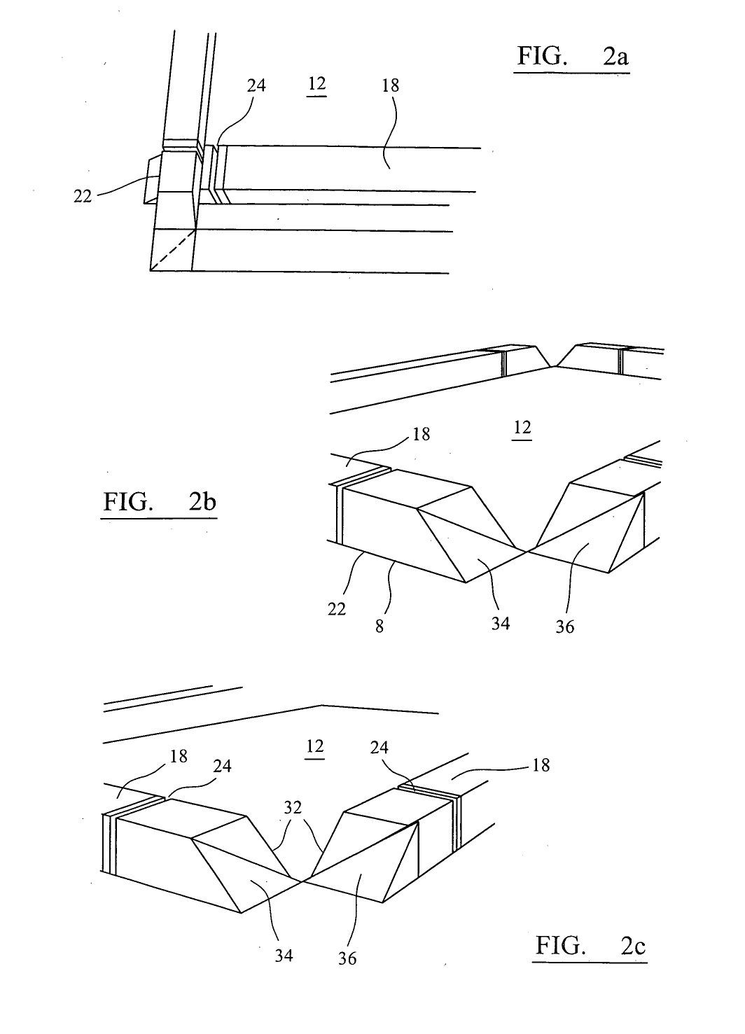

FIGS. 1a-1c illustrate the components of the box canvas apparatus in one embodiment;

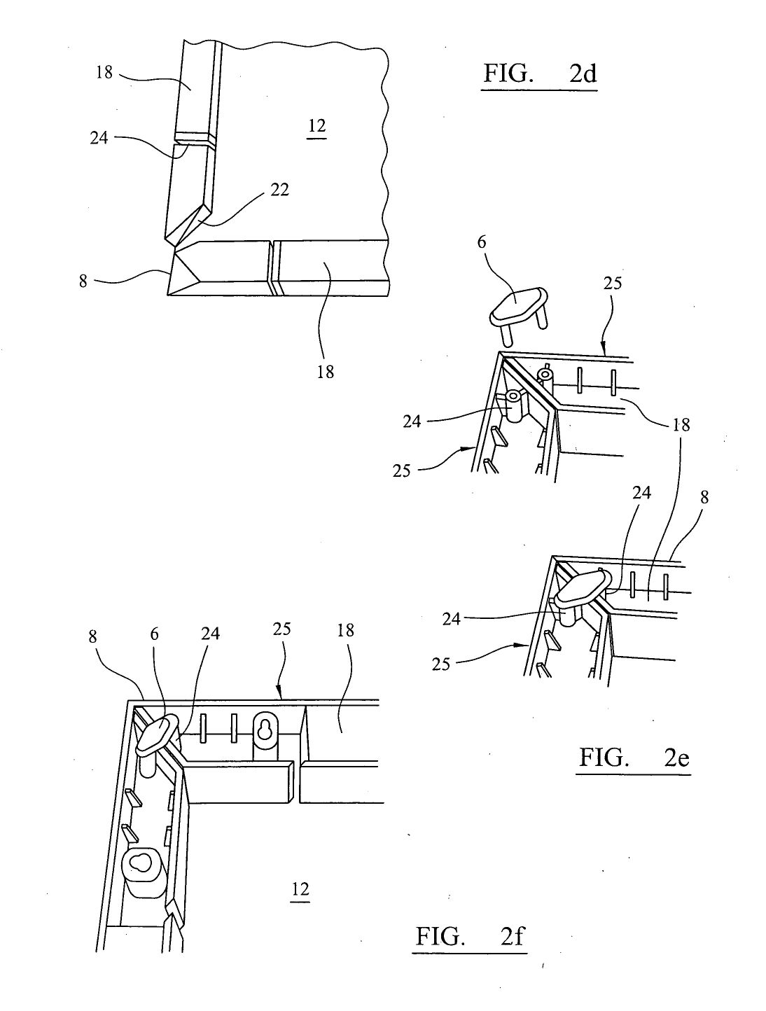

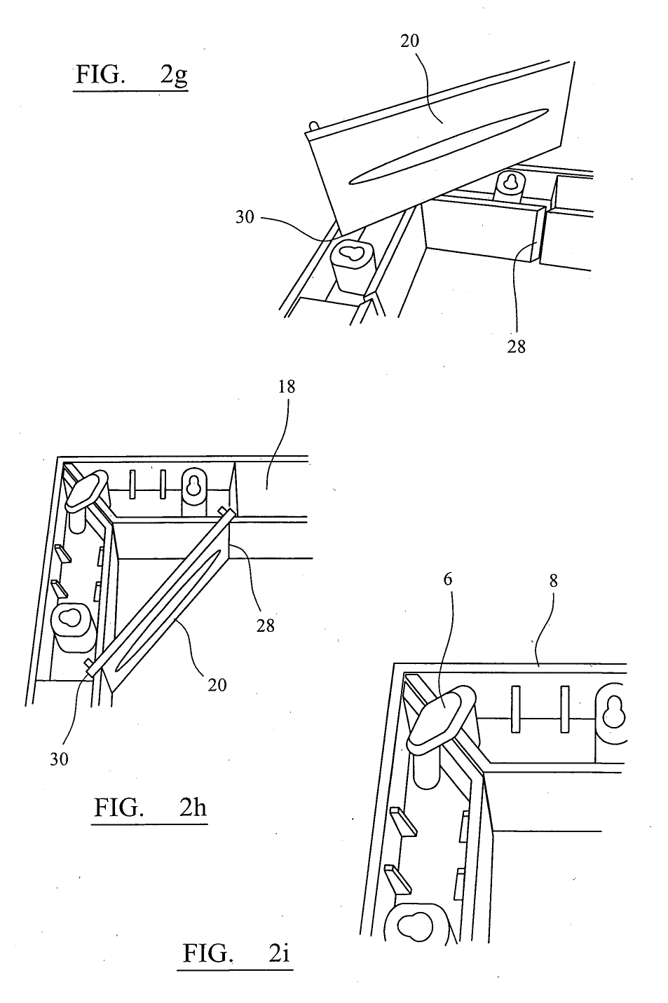

FIGS. 2a-2j illustrate the method steps involved in constructing the box canvas in one embodiment;

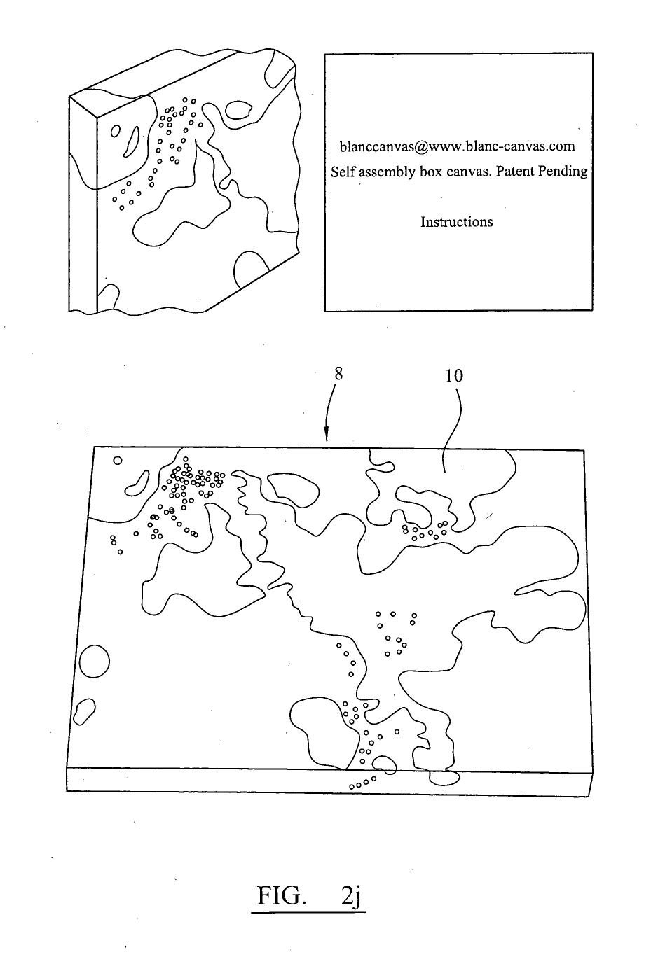

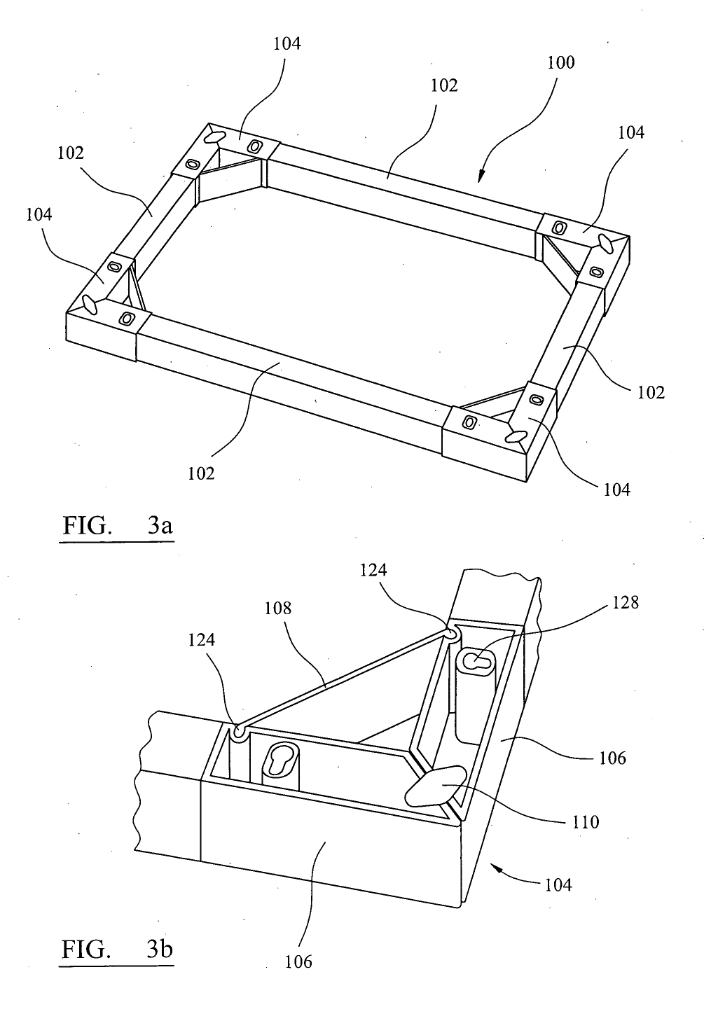

FIGS. 3a-3f illustrate the components of box canvas apparatus according to a further embodiment;

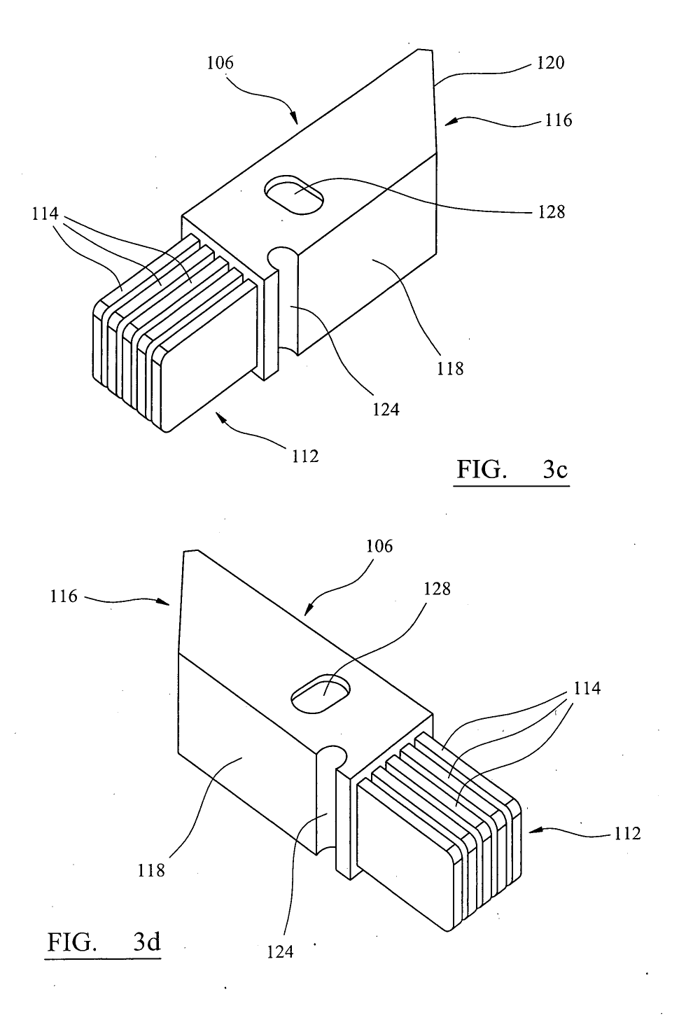

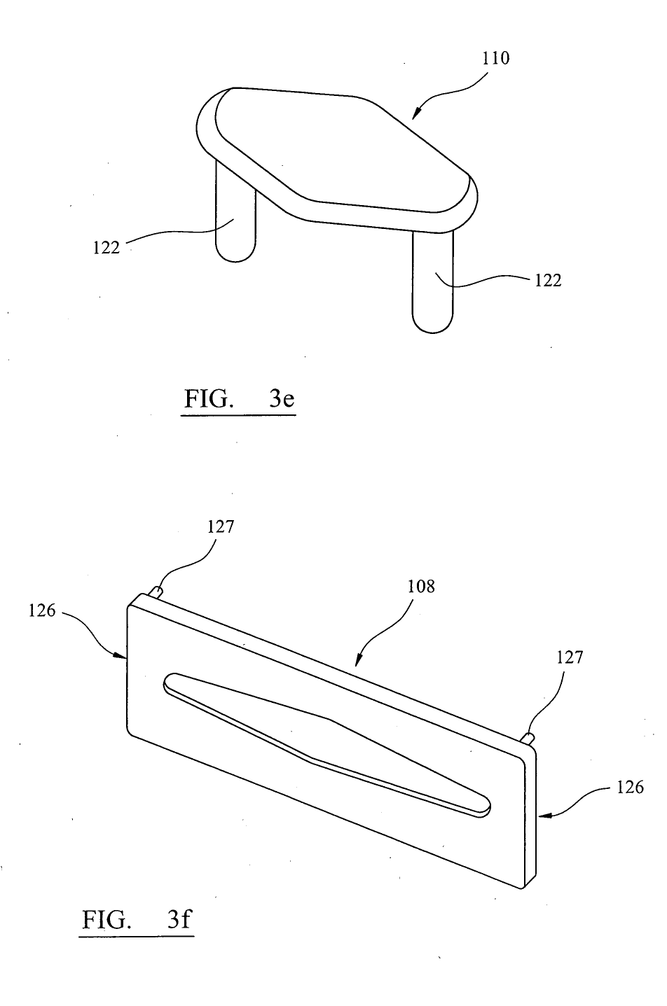

FIGS. 4a-c illustrate the components of a hanging system for hanging the box canvas apparatus; and

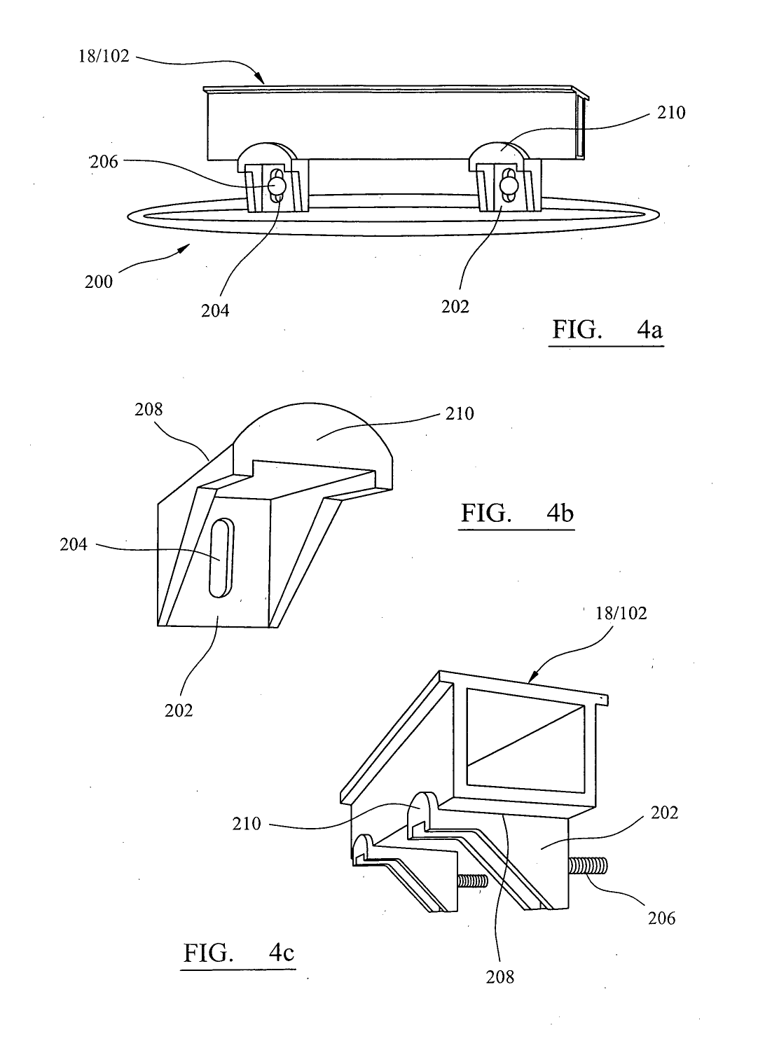

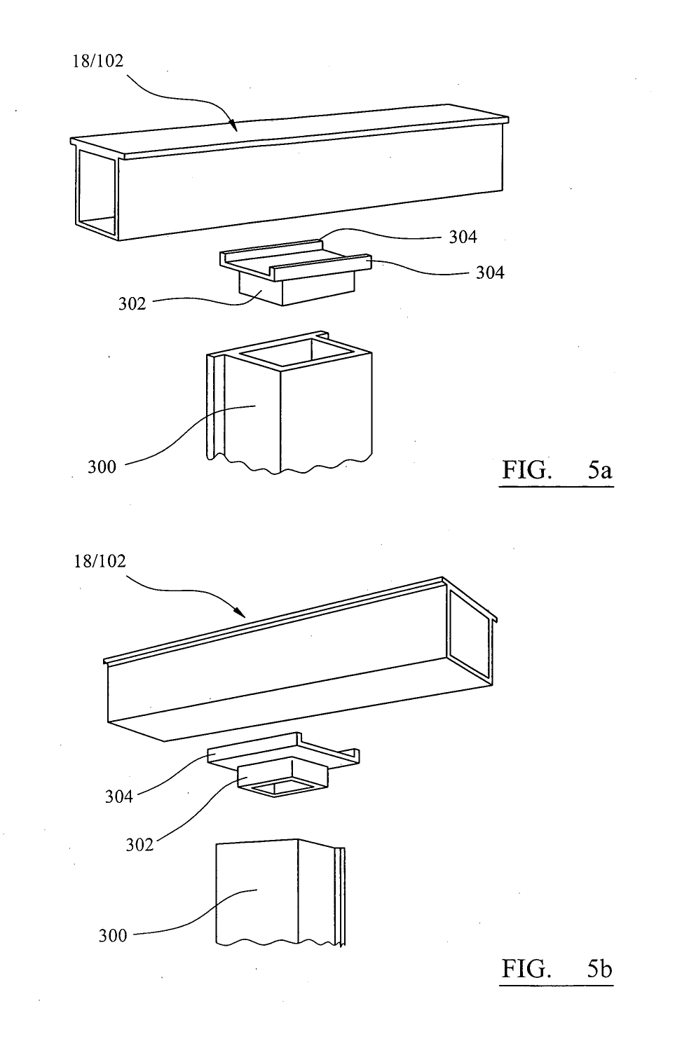

FIGS. 5a-c illustrate the components of a support strut for the box canvas apparatus.

Referring firstly to FIGS. 1a-2j, there is illustrated apparatus and a method for constructing a box canvas in a cost effective and easy manner, thereby allowing a user without special training and skill to construct a box canvas.

The box canvas apparatus in the first described embodiment includes frame means 4 for forming a box frame, engagement means in the form of a plurality of U-shaped pins 6 and a canvas 8 having a front surface 10 and a rear surface 12 which is to be stretched over the box frame when assembled.

The canvas 8 is formed from a material which has a certain level of resilience and/or flexibility to allow it to be stretched over the box frame when constructed.

The rear surface 12 of canvas 8 has a plurality of markings 14 printed thereon and preferably adjacent the peripheral edge 16 of the canvas. The markings define where the frame means are to be located during construction of the box frame.

More particularly, the frame means includes a plurality of peripheral frame members 18 (only some of which have been shown for the purposes of clarity but four are provided for the construction of a square or rectangular box frame for producing the square or rectangular box canvas shown in FIG. 2j). The peripheral frame members 18 form the outer frame for the box frame and are typically joined in an end to end manner to form the required shape of the box frame, which in this case is substantially rectangular. The frame means further includes a plurality of support members 20 which are provided at an acute angle between two adjacent frame members in the corners thereof to tension the corners of the box frame and provide the structure with strength and rigidity.

Each frame member 18 is typically an elongate arm member having first and second ends 22, each end 22 being tapered or angled. The ends in this embodiment are typically angled at approximately 45 degrees to allow the ends of two adjacent frame members 18 to be brought together to form a substantially 90 degrees corner or angle between the members. However, it will be appreciated that the ends of the frame members can be provided at any suitable angle depending on the shape of the final box frame. Each end of the frame members typically has a narrowing taper from an inner surface towards an outer surface.

Location means in the form of a first set of apertures 24 are provided adjacent the end 22 of each frame member 18. Each aperture 24 is for the location of a free end 26 of U-shaped pins 6.

Further location means in the form of a set of recesses 28 are provided on each frame member 18 for the location of free ends 30 of support members 20. Recesses 28 are located a pre-determined spaced distance apart from ends 22 and apertures 24 of frame members 28 and are preferably located towards the centre of each frame member. Two spaced apart recesses 28 are provided on each frame member 18 and are angled away from each other, as shown in FIG. 2h. The longitudinal axis of the recesses 28 are typically at right angles to the longitudinal axis of the frame members 18.

In accordance with the present invention, canvas 8 is located on a surface with the front surface 10 in contact with the surface and the rear surface 12 uppermost.

The markings 14 on rear surface 12 are each individually labelled (such as with a number or letter for example) and correspond to labels provided on the frame members 18. Thus, a user matches the correct marking with the correct frame member and positions the frame member in the correct location defined by the corresponding marking on the canvas, as shown in FIG. 2a.

Attachment means are provided on rear surface 12 of the canvas 8 adjacent the markings in the form of adhesive 17. There is preferably a peelable or removable backing layer covering the adhesive which can be removed prior to use to reveal the adhesive. As such, when the frame members are positioned in the correct locations on the canvas, they are adhered to the adhesive 17. Pressure may be required to be applied by the user on the frame members in the direction of the canvas to adhere the frame members securely to the rear surface of the canvas. It will be appreciated that other forms of attachment means other than adhesive with a backing layer could be provided if required.

The frame members 18 are typically arranged adjacent the peripheral edge of the canvas 8 with complementary tapered ends of adjacent members facing towards each other, as shown in FIGS. 2a-2c. A corner flap 32 of canvas is left between ends 22 of frame members 18. This corner flap 32 is then cut diagonally using a knife, pair of scissors or other suitable cutting means from an outer edge to an inner edge of the canvas flap to form two tabs 34, 36. Each tab 34, 36 is then folded towards and adhered to the end 22 of the nearest frame member, as shown in FIGS. 2b and 2c. The front surface 8 of the canvas is now visible over the rear ends 22 of the frame members.

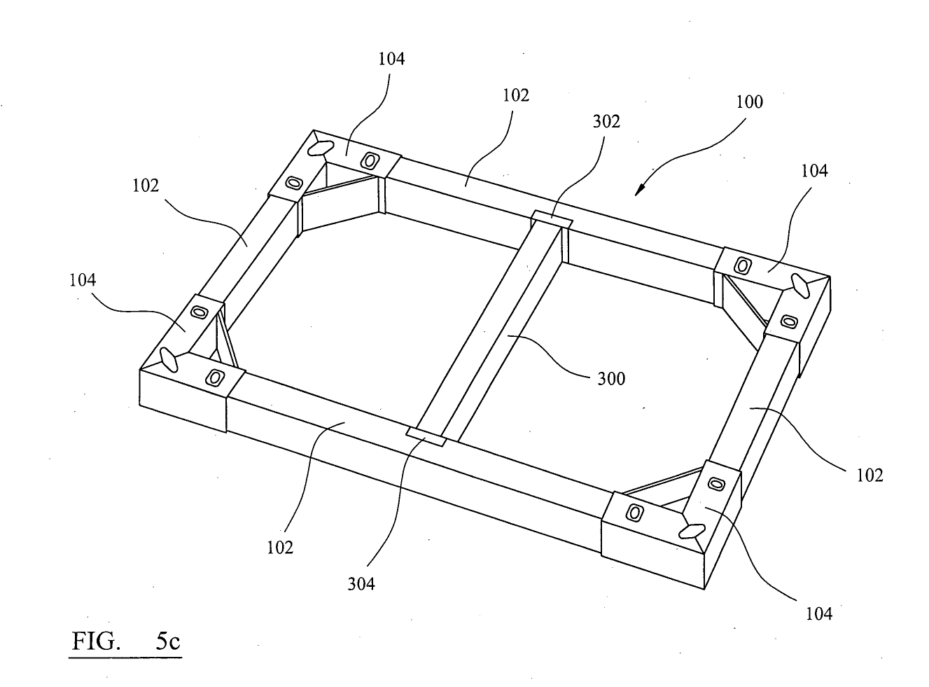

Each adjacent frame member 18 is then folded inwardly towards the centre of the canvas through approximately 90 degrees, as shown in FIG. 12d, thereby bringing ends 22 of adjacent frame members together to form a substantially right angled corner. The members are held in position using pin 6. More particularly, apertures 24, which originally face outwardly of the canvas when the members 18 are first located onto rear surface 12 of canvas 8, are moved through approximately 90 degrees to face in an upwardly direction (i.e. substantially right angles to the front of the canvas) after the folding process. Each sharpened end 26 of pin 6 is then located in adjacent apertures 24 of adjacent frame members 18 to join the same together, as shown in FIGS. 2e, 2f and 2i. This folding process has also resulted in the front 8 of the canvas covering side walls 25 of the box canvas.

When all four corners of the box frame have been constructed in the above described manner, support members 20 are located in place to maintain the rigidity and strength of the box frame. More particularly, the free ends 30 of a support member 20 are slidably located in the angled recesses 28 of frame members 18, such that support members are located diagonally between two adjacent frame members 18 adjacent each corner, as shown in FIGS. 2g and 2h.

Once constructed, the box canvas can be turned over, to provide a neat and stretched box canvas image, as shown in FIG. 2j.

Although the frame members shown in FIGS. 1a-2j are formed from wood and are joined together via one or more pins, it will be appreciated that other forms of material and engagement means can be used to form the box frame, such as metal, plastic, rubber and/or the like. An example of alternative materials and engagement means are shown in the embodiment described with reference to FIGS. 3a-3f.

In this embodiment the box frame 100 is formed from frame members 102 in the form of elongate hollow sleeve members which are joined together via corner components 104. The sleeve members 102 and corner components 104 are typically formed from injection moulded plastic and extruded plastic.

Each corner component 104 further includes frame member end pieces 106, support member 108 and U-shaped pin 110. End pieces 106 have a first end 112 comprising a plurality of rib members 114, and a second end 116. First end 112 is of slightly smaller dimensions than second end 116 and hollow sleeve frame member 102, thereby allowing end 112 to be inserted into the open end of hollow sleeve frame member 102 for engagement therein. The outer surface of body portion 118 of end piece 106 is substantially flush with the outer surface of frame member 102 when end 112 is engaged in frame member 102. Ribs 114 provide end piece 106 with strength and rigidity when engaged in frame member 102.

As with frame members 18, end piece 106 has a first aperture 120 for the location of an end 122 of pin 110. Aperture 120 is substantially complementary to end 122 to allow secure engagement between the same in use. An elongate recess 124 is provided on an inner edge (substantially tranverse to the longitudinal axis of the end piece) of end piece 106 to allow slidable engagement of an end 126 of support member 108 therein. The ends 126 of support member 108 can be provided with one or more protruding feet 127 to increase the engagement with complementary shaped apertures defined in recess 124.

One or more further apertures 128 can be defined on end piece 106 to allow hanging means, such as one or more hooks, string, wired and/or the like to be inserted therein to hang the box canvas from a suitable wall surface when assembled.

End 116 of end piece 106 is tapered in a similar manner to end 22 of frame member 18 to allow a substantially right angled corner to be formed between adjacent frame members.

The frame in FIGS. 3a-3f can be constructed in a similar manner to the frame constructed in FIGS. 1a-2j.

In a further alternative embodiment, the box frame is formed from frame members in the form of elongate hollow sleeve members which are joined together via corner components in a similar manner to that described above with reference to FIGS. 3a-f. The sleeve members are formed from an extruded metal, such as aluminium, and the corner components are formed from injection moulded plastic.

Referring now to FIGS. 4a-c, a hanging system 200 for use with the box frames of any embodiment of the invention is described. The hanging system 200 comprises at least one hanging clip 202, as shown in FIG. 4c.

The hanging clip 202 comprises an aperture 204 for receiving fixing means 206, for example nails or screws. The fixing means 206 are operable to retain the hanging clip 202 on a wall surface (not shown) via the aperture 204. The aperture 204 is elongate in the vertical orientation to allow adjustment of the vertical position of the hanging clip 202 with respect to the fixing means 206.

The hanging clip 202 further comprises a flat surface 208 for receiving a sleeve member 102 or frame member 18 of the box frame. The flat surface 208 further comprises a lip 210. The lip 210 is operable to prevent the frame member 18 or sleeve member 102 from slipping off the flat surface 208 of the clip 202.

In use, the or each hanging clip 202 is secured to a wall surface using fixing means 206. The box frame is then hung on the clips 202 by placing the frame member 18 or sleeve member 102 on the flat surface 208 of the clip such that the member 18/102 is enclosed, on one side, by the wall surface and, on the opposite side, by the lip 210.

Referring now to FIG. 5a-c, a support strut 300 for the box frame is described. The support strut 300 is operable to be positioned in the centre of the box frame to provide further support to the frame, especially for large frames. The support strut 300 is adapted to connect to a clip 302 for securing the strut 300 to the box frame. The clip 302 is inserted into the extruded strut 300 as shown in FIGS. 5a and b. The clip 302 then grips the frame member 18 or sleeve member 102 with the raised edges 104,106.

One or more support struts 300 may be used to provide extra support to the centre of a box frame.

It will be appreciated that the box frame can be formed in any suitable size, shape and/or design and the number and shape of the frame members and/or end pieces will alter accordingly.

The box canvas apparatus of the present invention provides a simple quick solution for the framing of images (not just canvas). the frame can be shipped as a kit requiring no tools, experience or glues to assemble. the frame is made from recycled materials (plastic and metal). you frame is waterproof so can be used outdoors.

Furthermore, the apparatus can be provided as a retail kit on the highstreet including a voucher system to link the image processing to a particular website

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A box canvas apparatus, said apparatus including a canvas and frame means, said canvas having a front surface and a rear surface, the rear surface having marking means defined thereon for marking out the location of said frame means in use, said apparatus further including attachment means for attaching the frame means to the canvas when positioned in a correct location on the marking means.

2. The apparatus according to claim 1, wherein the frame means includes a plurality of frame members which are assembled in use to define a box frame over which the canvas is stretched.

3. The apparatus according to claim 2, wherein at least some of the frame members are located on the marking means on the rear surface of the canvas during assembly and are attached to the canvas and/or to adjacent frame members via the attachment means.

4. The apparatus according to claim 2, wherein each frame member has a unique label that corresponds to a label defined by the marking means.

5. The apparatus according to claim 2, wherein the frame members include location means for locating one or more further frame members and/or engagement means therewith, the location means including a longitudinal axis.

6. The apparatus according to claim 2, wherein the frame members include free ends and at least one free end of a first frame member is provided with a pre-determined taper or angle to allow an adjacent ends of a second frame member to be brought together into engagement to define a corner of a pre-determined angle.

7. The apparatus according to claim 5, wherein the longitudinal axis of the location means is positioned so that during construction of the apparatus the longitudinal axis is moved from a first position, wherein it is substantially parallel to the plane of the main canvas, to a second position, wherein it is substantially transverse to the plane of the main canvas.

8. The apparatus according to claim 5, wherein the location means includes one or more grooves, apertures or recesses.

9. The apparatus according to claim 5, wherein the engagement means include one or more pins, staples, clips and/or the like.

10. The apparatus according to claim 1, wherein the frame means are attached to the canvas by adhesive, hook and loop material, one or more pins, staples, clips and/or the like.

11. The apparatus according to claim 1, wherein the canvas is formed from a material which is sufficiently flexible and/or resilient to allow the same to be stretched over the frame means in use.

12. The apparatus according to claim 1, wherein the marking means are defined on the rear of the canvas.

13. The apparatus according to claim 1, wherein hanging means are provided on or associated with the frame means to allow the box canvas to be hung from a suitable wall surface in use.

14. The apparatus according to claim 13, wherein the hanging means includes one or more apertures, hooks, wire, string and/or the like.

15. A method of forming a box canvas, said method including the steps of locating frame means onto marking means defined on a rear surface of a canvas, and attaching the canvas to the frame means to stretch the canvas over the frame means to form the final box canvas.

16. (canceled)

17. (canceled)
